(19) United States
(12) Patent Application Publication
(10) Pub. No.: US 2009/0111076 A1
(43) Pub. Date: Apr. 30, 2009

(54) Method for teaching critical thinking

(76) Inventor: Kevin S. Winterrowd, Yukon, OK (US)

Correspondence Address: James T. Robinson;Exclusivity-Law, Inc., 222 East Main Street, Norman, OK, 73069-1303, US

(21) Appl. No.: 11/978,436

(22) Filed: Oct. 29, 2007

(51) Int. Cl. G09B 19/00

(52) U.S. Cl. 434/236

(57) ABSTRACT

A method for teaching critical thinking to students, using pre-selected teaching materials relating to a pre-selected subject having at least one concept relating to the pre-selected subject, consists of teaching the students to identify the concept under consideration (Step 1), teaching the student to analyze the significance of the concept in relation to at least one relatively narrower context (Step 2), and teaching the student to evaluate the significance of the concept in relation to at least one relatively broader context (Step 3).

### BACKGROUND OF THE INVENTION

1. Field of the Invention

This invention relates to education, and, more particularly, but not by way of limitation, to a method for teaching critical thinking. Optionally, the method for teaching critical thinking process is represented by a critical thinking triangle. From the student's perspective, the invention is a method for learning how to engage in critical thinking using the critical thinking triangle.

2. Discussion

Following the 1948 Convention of the American Psychological Association, B. S. bloom took a lead in formulating a classification of the goals of the educational process. Three domains of educational activities were identified. The first of these, the Cognitive Domain, is a knowledge-based domain consisting of six levels. The second, the Affective Domain, is an attitudinal-based domain consisting of five levels. The third, the Psychomotor Domain, is a skills-based domain consisting of six levels. Eventually, Bloom and his co-workers established a hierarchy of educational objectives, generally referred to as Bloom's Taxonomy, which divides cognitive objectives ranging from the simplest behavior to the most complex.

Bloom's Taxonomy is a multi-tiered model of classifying thinking according to six cognitive levels of complexity. Over the years, the levels have often been depicted as a stairway, leading many teachers to encourage their students to “climb to a higher level of thought.” The lowest three levels are knowledge, comprehension, and application. The highest three levels are analysis, synthesis, and evaluation.

Bloom's Taxonomy has been condensed, expanded, and reinterpreted in a variety of ways. It has provided a point of departure for numerous research projects and papers. During the 1990s, a former student of Bloom's, Lorin Anderson, led a new assembly which met for the purpose of updating Bloom's Taxonomy, hoping to add relevance for 21^{st} century students and scholars. The effort result in a Revised Bloom's Taxonomy (RBT). Published in 2001, the revision includes several changes in three broad categories: terminology, structure, and emphasis.

Changes in terminology between the two versions are the most obvious differences. Bloom's six major categories (evaluation, synthesis, analysis, application, comprehension, and knowledge) were changed from noun to verbs. The “lowest” level of the original taxonomy, knowledge, was renamed “remembering.” Finally, comprehension and synthesis were renamed understanding and creating, respectively. The six categories in the RBT are remembering, understanding, applying, analyzing, evaluating, and creating.

According to the Revised Bloom's Taxonomy, remembering is defined as retrieving, recognizing, and recalling relevant knowledge from long-term memory. Understanding is defined as constructing meaning from oral, written, and graphic messages through interpreting, exemplifying, classifying, summarizing, inferring, comparing, and explaining. Applying is defined as carrying out or using a procedure through executing or implementing. Analyzing is defined as breaking material into constituent parts, determining how the parts relate to one another and to an overall structure or purpose through differentiating, organizing, and attributing. Evaluating means making judgments based on criteria and standards through checking and critiquing. Finally, Creating means putting elements together to form a coherent or functional whole (reorganizing elements into a new pattern or structure through generating, planning, or producing).

As history has shown, this well known, widely applied scheme filled a void and provided educators with one of the first systematic classifications of the process of thinking and learning. As teachers struggle to help students acquire both knowledge and critical thinking skills, Bloom's Taxonomy and the Revised Bloom's Taxonomy remain easy for teachers to understand. Teachers must measure their students' ability. Accurate measurement of students' ability requires a classification of levels of intellectual behavior important in learning. Bloom's Taxonomy and the Revised Bloom's Taxonomy provided the measurement tool for thinking.

Today's teachers must make tough decisions about how to spend their classroom time. The use of Bloom's Taxonomy and the Revised Bloom's Taxonomy provide a framework for the teacher to identify the fit of each lesson plan's purpose, essential question, goal, or objective.

Yet, neither Bloom's Taxonomy nor the Revised Bloom's Taxonomy translates directly into classroom activities. Accordingly, what is needed is a method of teaching (and learning) which incorporates the teachings of Bloom's Taxonomy (and the RBT) in a form which can be applied systematically and effectively in the classroom.

### SUMMARY OF THE INVENTION

According to a method for teaching critical thinking, the student is first to identify the concept or fact under consideration (Step 1). Next, the student is taught to analyze the significance of the concept or fact in relation to at least one relatively narrower context (Step 2). Then, the student is taught to evaluate the significance of the concept in relation to at least one relatively broader context (Step 3). The method also provides a triangular critical thinking diagram wherein each step is represented and the student progresses from Step 1 (a single point) to Step 2 to Step 3 within the critical thinking diagram.

An object of the present invention is to provide a classroom-appropriate method of teaching critical thinking to students.

Yet another object of the present invention is to provide a framework in which students can learn critical thinking skills.

Yet another object of the present invention is to provide a graphic representation for use by students in evaluating their responses to questions regarding concepts relating to pre-selected teaching materials.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a diagram showing the steps of applicant's method for teaching critical thinking.

FIG. 2 is a diagram showing the steps of another method for teaching critical thinking according to applicant's invention.

FIG. 3 is a diagram showing the steps of a method for learning critical thinking according to applicant's invention.

FIG. 4 is a view of a triangular critical thinking diagram according to applicant's invention.

FIG. 5 is a view of another critical thinking triangle according to applicant's invention.

FIG. 6 is a view of another critical thinking triangle according to applicant's invention.

FIG. 7 is a view of another critical thinking triangle according to applicant's invention.

FIG. 8 is a view of another critical thinking triangle according to applicant's invention.

FIG. 9 is a view of another critical thinking triangle according to applicant's invention.

### DETAILED DESCRIPTION OF THE INVENTION

In the following description of the invention, like numerals and characters designate like elements throughout the figures of the drawings.

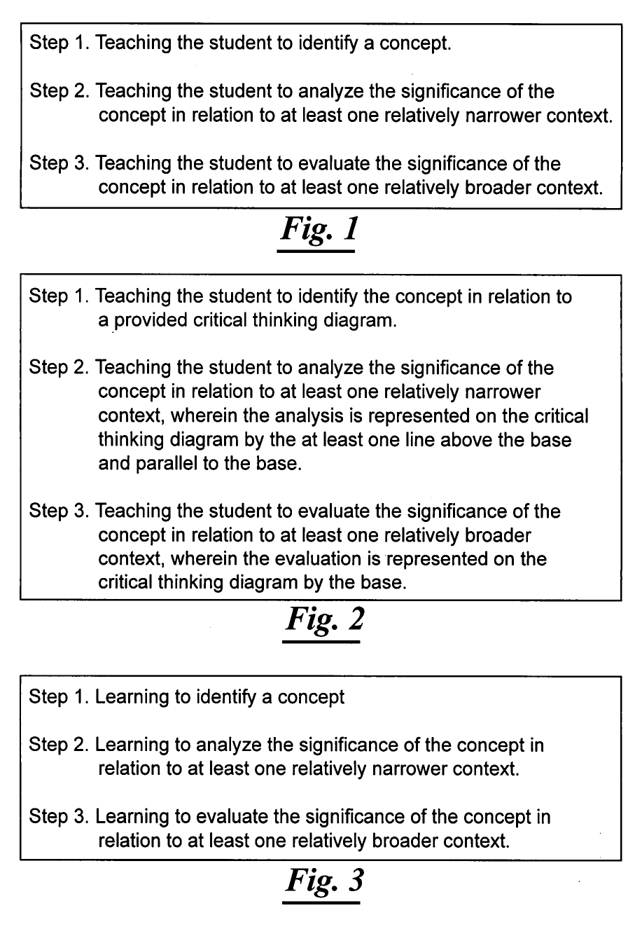

Referring now to FIG. 1, shown therein are the related steps of applicant's method for teaching critical thinking to students. In Step 1, the students are taught to identify the concept under consideration. In Step 2, the students are taught to analyze the significance of the concept in relation to at least one relatively narrower context. In Step 3, the students are taught to evaluate the significance of the concept in relation to at least one relatively broader context.

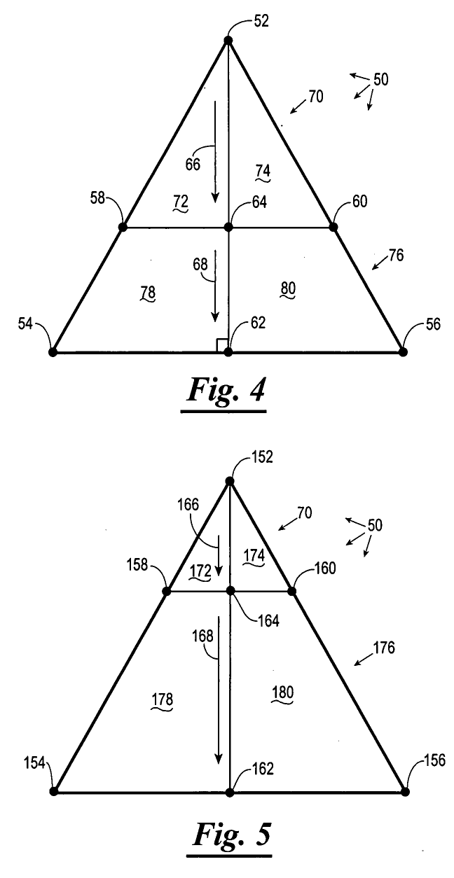

Referring now to FIG. 2, shown therein are the related steps of another method for teaching critical thinking to students according to applicant's invention. Each step is represented on a critical thinking diagram (See FIG. 4). In Step 1, the students are taught to identify the concept under consideration wherein the concept is represented by a point on the critical thinking diagram shown in FIG. 4. In Step 2, the students are taught to analyze the significance of the concept in relation to at least one relatively narrower context, wherein the analysis step is represented on the critical thinking diagram shown in FIG. 4. In Step 3, the students are taught to evaluate the significance of the concept in relation to at least one relatively broader context. The evaluation step is represented on the critical thinking diagram shown in FIG. 4.

Referring now to FIG. 3, shown therein are the related steps of applicant's method for learning critical thinking. In Step 1, the students learn to identify the concept under consideration. In Step 2, the students learn to analyze the significance of the concept in relation to at least one relatively narrower context. In Step 3, the students learn to evaluate the significance of the concept in relation to at least one relatively broader context.

Referring now to FIG. 4, a critical thinking triangle 50 according to the present invention is defined by points 52, 54, and 56 forming a left leg 52-54, a right leg 52-56, and a base 54-56. Points 58, on the left leg 52-54, and 60, on the right leg 52-56, define a line 58-60 positioned between the point 52 and the base 54-56 and parallel to the base 54-56. A point 62 on the base 54-56 cooperates with the point 52 to define a vertical line 52-62 perpendicular to the base 54-56. The vertical line 52-62 intersects the line 58-60 at a point 64. As will be discussed more fully below, an arrow 66 represents a progression from the point 52 toward the point 64 on the line 58-60. An arrow 68 represents a further progression from the point 64 toward the point 62 on the base 54-56.

Still referring to FIG. 4, points 52, 58, and 60 define a contained triangle 70 having legs 52-56, 52-60, and a base 58-60. The contained triangle 70 further contains a left triangular portion 72 defined by legs 52-58, 52-64 and a base 58-64 and a right triangular portion 74 defined by legs 52-60, 52-64 and a base 64-60. The points 54, 56, 58, and 60 define a contained trapezoid 76 having a left leg 54-48, a right leg 56-60, a top 58-60, and a base 54-56. The contained trapezoid 76 further contains a left trapezoidal portion 78, defined by lines 54-58, 54-62, 58-64, and 62-64, and a right trapezoidal portion 80, defined by lines 62-56, 56-60, 60-64, and 62-64.

Still referring to FIG. 4, a downwardly-pointing arrow 66,indicates progression from the point 52 toward the line 58-60. Another downwardly-pointing arrow 68 indicates progression from the line 58-60 toward the base 54-56.

It will be understood by one skilled in the art that the present method for teaching critical thinking is applicable to all disciplines, including, but not limited to, arts and sciences (including the fine arts and the earth sciences), engineering, mathematics, business, education, history, the social sciences, the study of law, the study of medicine, the study of dentistry, the study of accounting, and language arts. Specifically included are the following: algebra, geometry, calculus, biology, zoology, geology, chemistry, physics, world history, U.S. history, government, political science, chemical engineering, mechanical engineering, electrical engineering, English, literature, composition, social studies, psychology, economics, health, physical education, and reading. It will be further understood that, while the present method for teaching critical is universally applicable across all disciplines, the present method, with its utilization of a critical thinking diagram, is especially well suited for secondary school students.

To further illustrate the present method for teaching critical thinking, we will discuss an example involving a World History class wherein the pre-selected teaching materials include a unit on World War I. Within the unit on World War I, a section is devoted to the Treaty of Versailles, which brought an official end to World War I. Step 1 questions typically begin with verbs such as tell, list, describe, relate, locate, write, find, state, name, identify, or define.

| | Teacher | |
|---|---|---|
| Step | request | Desired student response |
| 1. Identify the | Define/describe the | Signed in 1919, the Treaty of |
| concept/event under | Treaty of Versailles | Versailles was a treaty |
| consideration | | between the Allies and |
| | | Germany (from pre-selected |
| | | teaching materials). |
| 2. Analyze the | Analyze the treaty's | The Treaty of Versailles |
| significance of the | significance with respect | brought World War I to an |
| concept/event in | to World War I. | official close (from materials). |
| relation to a relatively | | or |
| narrower context. | | The Treaty of Versailles |
| | | imposed. payment of harsh |
| | | reparations on post-War |
| | | Germany (from materials). |
| | | or |
| | | The Treaty of Versailles set |
| | | the stage for the rise of a |
| | | nationalistic Germany and the |
| | | Nazi Party (from materials). |
| 3. Evaluate | Evaluate the significance | The U.S. learned an important |
| | of the Treaty of | lesson. Instead of requiring |
| | Versailles on U.S. history | harsh reparations, a better |
| | and policy. | approach is to help defeated |
| | | enemies to rebuild and convert |
| | | them to trading partners and |
| | | allies (not included in |
| | | materials). Discuss later U.S. |
| | | actions following World War II. |

In the first step (See FIG. 1 and table, above), the teacher would teach the student to identify the 1919 Treaty of Versailles. In Step 2, the student would be taught to analyze the 1919 Treaty of Versailles with respect to World War I in 2-3 sentences drawing on information contained in the teaching materials. The student might point out that Germany was kept under blockade until she signed, that the Treaty of Versailles declared Germany responsible for the war, that the Treaty of Versailles required Germany to pay enormous war reparations and cede territory to the victors, that the harsh reparations and territorial losses caused enormous bitterness in Germany, giving rise to nationalist movements, especially the Nazis, or that the treaty contributed to one of the worst economic collapses in German history, sparking runaway inflation in the 1920s. In Step 3, the students might be asked to evaluate the concept in relation to a relatively broader context, preferably the students' lifetime experience or expectations. The students might be taught to consider lessons learned by the United States and its allies regarding treatment of defeated enemies, with costs for rebuilding paid, at least in part, by the American taxpayer, and with long-term economic and political commitments.

Referring now to FIGS. 1 and 4 and the Treaty of Versailles example, the student would be taught that Step 2 (analysis) is represented by the line 58-60 in FIG. 4 and, further, that Step 3 (evaluation) is represented by the base 54-56 in FIG. 4. The relatively narrower context (Step 2) is the impact on post-war Germany. The relatively broader context (Step 3) would be the long-lasting impact on U.S. policy with respect to defeated enemies. The arrow 66 indicates a progression of the student's thinking from a statement of identification of the concept (represented by the point 54), without little else, to analysis of the significance of the concept in relation to a relatively narrower context (represented by the line 58-60). The arrow 68 indicates a progression of the student's thinking from the analysis of the significance of the concept in relation to a relatively narrower context (Step 2) to evaluation of the significance of the concept in a relatively broader context (represented by the base 54-56; Step 3).

Referring now to FIG. 5, another critical thinking triangle 150 according to the present invention is defined by points 152, 154, and 156 forming a left leg 152-154, a right leg 152-156, and a base 154-156. Points 158, on the left leg 152-154, and 160, on the right leg 152-156, define a line 158-160 positioned between the point 152 and the base 154-156 and parallel to the base 154-156. A point 162 on the base 154-156 cooperates with the point 152 to define a vertical line 152-162 perpendicular to the base 154-156. The vertical line 152-162 intersects the line 158-160 at a point 164. An arrow 166 represents a progression from the point 152 toward the point 164 on the line 158-160. An arrow 168 represents a further progression from the point 164 toward the point 162 on the base 154-156.

Still referring to FIG. 5, points 152, 158, and 160 define a contained triangle 170 having legs 152-156, 152-160, and a base 158-160. The contained triangle 170 further contains a left triangular portion 172 defined by legs 152-158, 152-164 and a base 158-164 and a right triangular portion 174 defined by legs 152-160, 152-164 and a base 164-160. The points 154, 156, 158, and 160 define a contained trapezoid 176 having a left leg 154-158, a right leg 156-160, a top 158-160, and a base 154-156. The contained trapezoid 176 further contains a left trapezoidal portion 178, defined by lines 154-158, 154-162, 158-164, and 162-164, and a right trapezoidal portion 180, defined by lines 162-156, 156-160, 160-164, and 162-164.

Still referring to FIG. 5, a downwardly-pointing arrow 166 indicates progression from the point 152 toward the line 158-160. Another downwardly-pointing arrow 168 indicates progression from the line 158-160 toward the base 154-156.

Referring now to FIG. 5 in conjunction with FIG. 1, the concept to be identified by the students in Step 1 is represented on the critical thinking diagram 150 as the point of intersection 152 of the two legs 152-154 and 152-156 above the base 154-156. In Step 2, the students are taught to analyze the significance of the concept in relation to at least one relatively narrower context. The analysis is represented on the critical thinking diagram by the line 158-160 parallel to the base 154-156. Finally, in Step 3 the students are taught to evaluate the significance of the concept in relation to at least one relatively broader context, wherein the evaluation is represented on the critical thinking diagram by the base 154-156.

Referring now to FIGS. 4 and 5, the distance between the point 52 and the point 64 in FIG. 4 is greater than the distance between the point 152 and the point 164 in FIG. 5, thereby suggesting a somewhat decreased progression between the Steps 1 and 2 in the critical thinking triangle 150 in FIG. 5 as compared to the progression between the Steps 1 and 2 as represented by the critical thinking triangle 50 in FIG. 4. In some cases and with certain teaching materials, the progress from concept identification/definition to analysis will be minimal. These differences are not significant. Rather, what is significant is the process by which the students learn to advance from a statement of fact (Step 1) to analysis (Step 2), wherein the students consider the significance of the fact in relation to a relatively narrower context, and then to evaluation (Step 3), wherein the students consider the significance of the fact in relation to a relatively narrower context.

It will be understood by one skilled in the art that the length of the lines 58-60 (FIG. 4) and 158-160 (FIG. 5), although shown as terminating at the legs 52-54, 52-56 of the critical thinking triangle 50 and the legs 152-154, 152-156 of the critical thinking triangle 150, respectively, is not intended to indicate a limitation on the relatively narrower context in which the concept is considered by the students in the analysis Step 2. The breadth of the students' analysis is determined by the teaching materials provided to the student (since the student response is drawn from the teaching materials) and the instructions given by the teacher. For example, the teacher may limit the students' response to 1-2 sentences in some cases, or the teacher may ask the students to provide 3 sentences in the analysis Step 2.

It will also be understood by one skilled in the art that, whereas Step 1 asks for a factual answer which is either right or wrong, Step 2 may have numerous answers all of which are acceptable so long as they are supported by the teaching materials. Step 3 of the present method for teaching critical thinking involves a combination of teaching materials content with student reaction, interaction, and evaluation, none of which are contained in the teaching materials. Step 3 may invoke cultural responses which may vary from student to student. The goal of Step 3 is to teach the student to evaluate the significance of a concept/fact under consideration in a relatively broader context, thereby facilitating retention of both the concept/fact under consideration and developing the student's ability to think beyond the bare concept/fact.

Referring still to FIGS. 4 and 5, the critical thinking triangles 50, 150 are isosceles triangles. Therefore, the distances to the left and right of the vertical lines 52-62 and 152-162, respectively, are equal, thereby suggesting a balanced analysis (Step 2) and a balanced evaluation (Step 3).

Referring now to FIG. 6, another critical thinking triangle 250 according to the present invention is defined by points 252, 254, and 256 forming a left leg 252-254, a right leg 252-256, and a base 254-256. Points 258, on the left leg 252-254, and 260, on the right leg 252-256, define a line 258-260 positioned between the point 252 and the base 254-256 and parallel to the base 254-256. A point 262 on the base 254-256 cooperates with the point 252 to define a vertical line 252-262 perpendicular to the base 254-256. The vertical line 252-262 intersects the line 258-260 at a point 264. An arrow 266 represents a progression from the point 252 toward the point 264 on the line 258-260. An arrow 268 represents a further progression from the point 264 toward the point 262 on the base 254-256.

Still referring to FIG. 6, points 252, 258, and 260 define a contained triangle 270 having legs 252-256, 252-260, and a base 258-260. The contained triangle 270 further contains a left triangular portion 272 defined by legs 252-258, 252-264 and a base 258-264 and a right triangular portion 274 defined by legs 252-260, 252-264 and a base 264-260. The points 254,256, 258, and 260 define a contained trapezoid 276 having a left leg 254-258, a right leg 256-260, a top 258-260, and a base 254-256. The contained trapezoid 276 further contains a left trapezoidal portion 278, defined by lines 254-258, 254-262, 258-264, and 262-264, and a right trapezoidal portion 280, defined by lines 262-256, 256-260, 260-264, and 262-264.

Still referring to FIG. 6, a downwardly-pointing arrow 266 indicates progression from the point 252 toward the line 258-260. Another downwardly-pointing arrow 268 indicates progression from the line 258-260 toward the base 254-256.

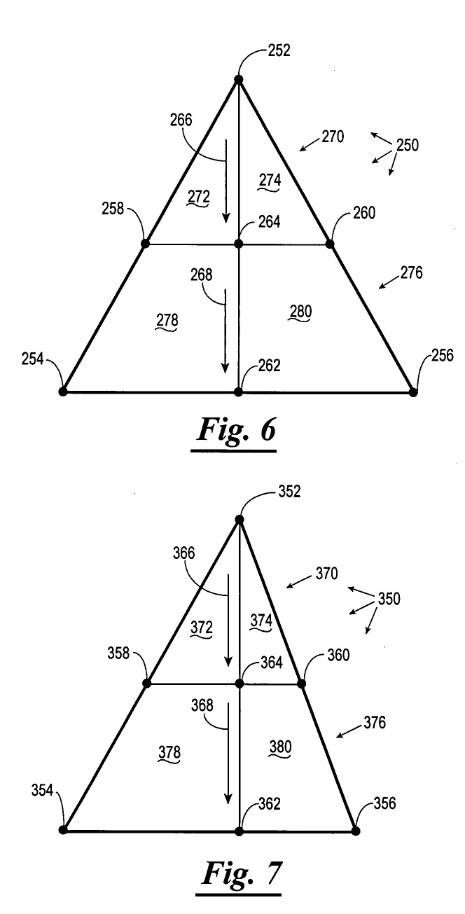

Referring now to FIG. 7, another critical thinking triangle 350 according to the present invention is defined by points 352, 354, and 356 forming a left leg 352-354, a right leg 352-356, and a base 354-356. Points 358, on the left leg 352-354, and 360, on the right leg 352-356, define a line 358-360 positioned between the point 352 and the base 354-356 and parallel to the base 354-356. A point 362 on the base 354-356 cooperates with the point 352 to define a vertical line 352-362 perpendicular to the base 354-356. The vertical line 352-362 intersects the line 358-360 at a point 364. An arrow 366 represents a progression from the point 352 toward the point 364 on the line 358-360. An arrow 368 represents a further progression from the point 364 toward the point 362 on the base 354-356.

Still referring to FIG. 7, points 352, 358, and 360 define a contained triangle 370 having legs 352-356, 352-360, and a base 358-360. The contained triangle 370 further contains a left triangular portion 372 defined by legs 352-358, 352-364 and a base 358-364 and a right triangular portion 374 defined by legs 352-360, 352-364 and a base 364-360. The points 354, 356, 358, and 360 define a contained trapezoid 376 having a left leg 354-358, a right leg 356-360, a top 358-360, and a base 354-356. The contained trapezoid 376 further contains a left trapezoidal portion 378, defined by lines 354-358, 354-362, 358-364, and 362-364, and a right trapezoidal portion 380, defined by lines 362-356, 356-360, 360-364, and 362-364.

Still referring to FIG. 7, a downwardly-pointing arrow 366 indicates progression from the point 352 toward the line 358-360. Another downwardly-pointing arrow 368 indicates progression from the line 358-360 toward the base 354-356.

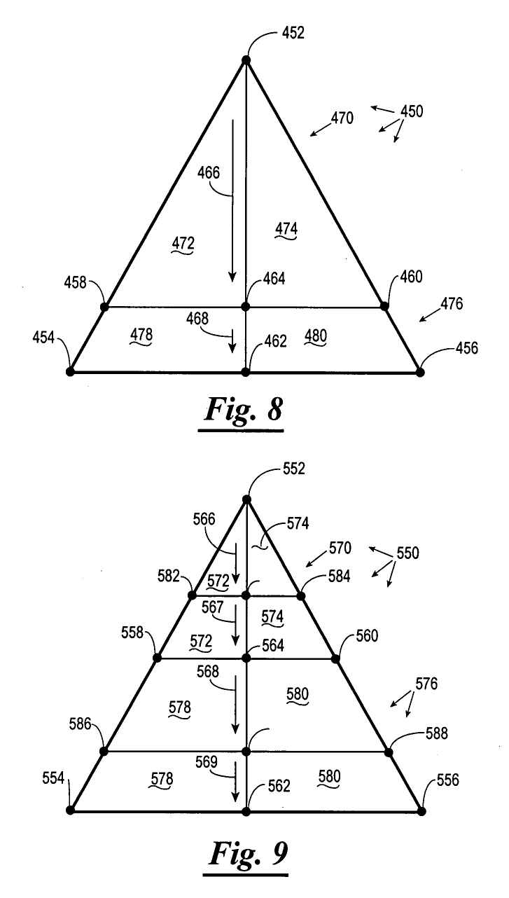

Referring now to FIG. 8, another critical thinking triangle 450 according to the present invention is defined by points 452, 454, and 456 forming a left leg 452-454, a right leg 452-456, and a base 454-456. Points 458, on the left leg 452-454, and 460, on the right leg 452-456, define s line 458-460 positioned between the point 452 and the base 454-456 and parallel to the base 454-456. A point 462 on the base 454-456 cooperates with the point 452 to define a vertical line 452-462 perpendicular to the base 454-456. The vertical line 452-462 intersects the line 458-460 at a point 464. An arrow 466 represents a progression from the point 452 toward the point 464 on the line 458-460. An arrow 468 represents a further progression from the point 464 toward the point 462 on the base 454-456.

Still referring to FIG. 8, points 452, 458, and 460 define a contained triangle 470 having legs 452-456, 452-460, and a base 458-460. The contained triangle 470 further contains a left triangular portion 472 defined by legs 452-458, 452-464 and a base 458-464 and a right triangular portion 474 defined by legs 452-460, 452-464 and a base 464-460. The points 454, 456, 458, and 460 define a contained trapezoid 476 having a left leg 454-458, a right leg 456-460, a top 458-460, and a base 454-456. The contained trapezoid 476 further contains a left trapezoidal portion 478, defined by lines 454-458, 454-462, 458-464, and 462-464, and a right trapezoidal portion 480, defined by lines 462-456, 456-460, 460-464, and 462-464.

Still referring to FIG. 8, a downwardly-pointing arrow 466 indicates progression from the point 452 toward the line 458-460. Another downwardly-pointing arrow 468 indicates progression from the line 458-460 toward the base 454-456.

Referring now to FIG. 9, another critical thinking triangle 550 according to the present invention is defined by points 552, 554, and 556 forming a left leg 552-554, a right leg 552-556, and a base 554-556. Points 558, on the left leg 552-554, and 560, on the right leg 552-556, define a line 558-560 positioned between the point 552 and the base 554-556 and parallel to the base 554-556. A point 562 on the base 554-556 cooperates with the point 552 to define a vertical line 552-562 perpendicular to the base 554-556. The vertical line 552-562 intersects the line 558-560 at a point 564. An arrow 566 represents a progression from the point 552 toward the point 564 on the line 558-560. An arrow 568 represents a further progression from the point 564 toward the point 562 on the base 554-556.

Still referring to FIG. 9, points 552, 558, and 560 define a contained triangle 570 having legs 552-556, 552-560, and a base 558-560. The contained triangle 570 further contains a left triangular portion 572 defined by legs 552-558, 552-564 and a base 558-564 and a right triangular portion 574 defined by legs 552-560, 552-564 and a base 564-560. The points 554, 556, 558, and 560 define a contained trapezoid 576 having a left leg 554-558, a right leg 556-560, a top 558-560, and a base 554-556. The contained trapezoid 576 further contains a left trapezoidal portion 578, defined by lines 554-558, 554-562, 558-564, and 562-564, and a right trapezoidal portion 580, defined by lines 562-556, 556-560, 560-564, and 562-564.

Still referring to FIG. 9, a downwardly-pointing arrow 566 indicates progression from the point 552 toward the line 558-560. Another downwardly-pointing arrow 568 indicates progression from the line 558-560 toward the base 554-556.

Still referring to FIG. 9, points 582 and 584 on the left leg 552-554 and the right leg 552-556, respectively, of the critical thinking triangle 550 define a line 582-584 representing an additional analysis (Step 2) between the point 582 (representing a Step 1 concept/fact) and the line 558-560 (representing the Step 2 analysis) The representation of an additional analysis step reflects a common occurrence wherein progressive analyses are appropriate. Points 586 and 588 on the left leg 552-554 and the right leg 552-556, respectively, of the critical thinking triangle 550 define a line 586-588 representing an additional evaluation Step 3 according to the present method. The representation of an additional evaluation step reflects a common occurrence wherein progressive evaluations are appropriate.

To further illustrate the method for teaching critical thinking according to the present invention, consider the case of students studying To Kill A Mockingbird, by Harper Lee, as part of an American Literature class. In a particular passage of interest for the purpose of this illustration, Scout, the young girl who narrates the story, tells of an incident wherein the Sheriff is faced with a rabid dog. To Scout's surprise, the Sheriff asks Atticus Finch, Scout's father, to take the Sheriff's rifle and shoot the dangerous dog. Scout was surprised because, in her life experience, she had never known Atticus Finch to have anything to do with guns. Atticus takes the rifle from the Sheriff, aims, fires, and kills the rabid dog with a single shot. Recognizing Scout's amazement, the Sheriff informs Scout that Atticus had long been the best shot in the county.

Applying applicant's method for teaching critical thinking to the students' study of the passage described above, the instructor would first (in Step 1), teach the students to identify the concept/fact under consideration. In this case, the concept/fact under consideration is the killing of the rabid dog by Atticus Finch. The Step 2 analysis (using the selected passage in conjunction with related materials from the book) would include a short discussion of Scout's lack of knowledge of her father's reputation as a crack shot. The Step 3 evaluation might include, among others, a discussion of the idea that we often do not know a person as well as we think—even members of our own family. Stated another way, the student might conclude that we should be open to seeing previously unseen aspects of those around us.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for teaching critical thinking to students using pre-selected teaching materials relating to a pre-selected subject having at least one concept relating to the pre-selected subject, the method for teaching critical thinking comprising the steps of:
teaching the students to identify the concept under consideration;
teaching the student to analyze the significance of the concept in relation to at least one relatively narrower context; and
teaching the student to evaluate the significance of the concept in relation to at least one relatively broader context.

2. The method of claim 1, wherein each step of the method is represented in a critical thinking diagram for reference by the students, the critical thinking diagram comprising;
a triangle having two legs, a base, and at least one line parallel to the base positioned between the two legs above the base;
wherein the concept is represented on the critical thinking diagram as the point of intersection of the two legs above the base;
wherein the analysis step is represented on the critical thinking diagram by the at least one line parallel to the base; and
wherein the evaluation step is represented on the critical thinking diagram by the base.

3. The method of claim 2, wherein the critical thinking diagram further comprises a vertical line connecting the point at the meeting of the legs of the triangle to the base, wherein the vertical line is perpendicular to the base.

4. The method of claim 2 wherein the pre-selected teaching materials relate to the fine arts.

5. The method of claim 2 wherein the pre-selected teaching materials relate to the sciences.

6. The method of claim 2 wherein the pre-selected teaching materials relate to business.

7. The method of claim 2 wherein the pre-selected teaching materials relate to education.

8. The method of claim 2, wherein the pre-selected teaching materials relate to mathematics.

9. The method of claim 2, wherein the pre-selected teaching materials relate to history.

10. The method of claim 2, wherein the pre-selected teaching materials relate to earth sciences.

11. The method of claim 2, wherein the pre-selected teaching materials relate to language arts.

12. A method for learning critical thinking by students using pre-selected teaching materials relating to a pre-selected subject having at least one concept relating to the pre-selected subject, the method for learning critical thinking comprising the steps of:
referring to a critical thinking diagram, the critical thinking diagram, further comprising a triangle having two legs, a base, and at least one line parallel to the base positioned between the two legs above the base;
identifying the concept under consideration in relation to the critical thinking diagram, wherein the concept is represented on the critical thinking diagram as the point of intersection of the two legs above the base;
analyzing the significance of the concept in relation to at least one relatively narrower context, wherein the analysis is represented on the critical thinking diagram by the at least one line parallel to the base; and
evaluating the significance of the concept in relation to at least one relatively broader context, wherein the evaluation is represented on the critical thinking diagram by the base.

13. The method of claim 12, wherein the critical thinking diagram further comprises a vertical line connecting the point at the meeting of the legs of the triangle to the base, wherein the vertical line is perpendicular to the base.

14. The method of claim 12, wherein the pre-selected teaching materials relate to the fine arts.

15. The method of claim 12, wherein the pre-selected teaching materials relate to the sciences.

16. The method of claim 12, wherein the pre-selected teaching materials relate to business.

17. The method of claim 12, wherein the pre-selected teaching materials relate to education.

18. The method of claim 12, wherein the pre-selected teaching materials relate to the social sciences.

19. The method of claim 12, wherein the pre-selected teaching materials relate to history.

20. The method of claim 12, wherein the pre-selected teaching materials relate to earth sciences.
